(19) United States
(12) Patent Application Publication
(10) Pub. No.: US 2009/0184899 A1
(43) Pub. Date: Jul. 23, 2009

(54) Organic light emitting display device

(76) Inventors: Tae-Jin Kim, Suwon-si (KR); Keum-Nam Kim, Suwon-si (KR); Hae-Kwan Seo, Suwon-si (KR); Bon-Seog Gu, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/320,111

(22) Filed: Jan. 16, 2009

(30) Foreign Application Priority Data
Jan. 18, 2008 (KR) 10-2008-0005618

(51) Int. Cl. G09G 3/30

(52) U.S. Cl. 345/76

(57) ABSTRACT

An organic light emitting display capable of minimizing the voltage drop of pixel power sources supplied to an organic light emitting display panel, contemplates an organic light emitting display panel including a pixel unit on which an image is displayed, and a plurality of first and second power source pads provided at two or more edges outside the pixel unit in order to receive first and second pixel power sources in at least two different directions, a plurality of tape carrier packages (TCP) electrically coupled to the organic light emitting display panel and including driving ICs for driving the organic light emitting display panel and power source lines for transmitting the first and second pixel power sources to the first and second power source pads, and driving boards electrically coupled to the TCPs in order to supply control signals for controlling the driving ICs and the first and second pixel power sources to the TCPs.

### CLAIM OF PRIORITY

This application makes reference to, incorporates the same herein, and claims all benefits accruing under 35 U.S.C. §119 from an application for ORGANIC LIGHT EMITTING DISPLAY earlier filed in the Korean Intellectual Property Office on 18 Jan. 2008 and there duly assigned Serial No. 10-2008-0005618.

### BACKGROUND OF THE INVENTION

1. Field of the Invention

The present invention relates to an organic light emitting display device, and more particularly, to an organic light emitting display device capable of minimizing a voltage drop of pixel power sources supplied to an organic light emitting display panel.

2. Description of the Related Art

Among flat panel display (FPD) devices, the organic light emitting display devices display images using organic light emitting diodes (OLEDs) that generate light by re-combination of electrons and holes. Since the organic light emitting display device has high response speed and is driven with low power consumption, the organic light emitting display device is spotlighted as a next generation display device.

Generally, the organic light emitting display device contemplates a pixel unit including a plurality of pixels, driving circuits for supplying driving signals to the pixel unit, and a power source supplying circuit for supplying pixel power sources to the pixel unit.

The pixels emit light with brightness corresponding to data signals supplied in synchronization with scan signals when the scan signals are supplied. Therefore, the organic light emitting display panel display device displays a predetermined image.

In the organic light emitting display device, the emission brightness of the pixels is affected by the voltage of the pixel power sources. That is, the pixel power sources determine the emission brightness of the pixels together with the data signals.

Therefore, in order to display an image with a uniform picture quality, the pixel power sources having the same voltage are to be supplied to each of the pixels.

A voltage drop IR Drop may however be generated while current passes through power source lines, because pixel power sources are direct current (DC) power sources having a predetermined voltage level.

In particular, the length of the power source lines increases when the size of the display panel of the organic light emitting display increases, therefore, a brightness variation between the pixels may increase in accordance with the distance between the pixels and a power source pad that receives the pixel power sources.

Therefore, a method of minimizing the voltage drop of the pixel power sources is required.

### SUMMARY OF THE INVENTION

It is therefore an object of the present invention to provide an improved organic light emitting display device in order to achieve a uniform picture quality of the organic light emitting display device.

It is another object of the present invention to provide an organic light emitting display device capable of minimizing the voltage drop of pixel power sources supplied to an organic light emitting display panel.

In order to achieve the foregoing and/or other objects of the present invention, an organic light emitting display device contemplates: an organic light emitting display panel having a pixel unit on which an image is displayed, and a plurality of first and second power source pads provided at two or more edges surrounding the pixel unit to receive first and second pixel power sources in at least two directions; a plurality of tape carrier packages (TCP) electrically coupled to the organic light emitting display panel, and including driving ICs for driving the organic light emitting display panel and power source lines for transmitting the first and second pixel power sources to the first and second power source pads; and driving boards electrically coupled to the TCPs in order to supply control signals for controlling the driving ICs and the first and second pixel power sources to the TCPs.

Additionally, the organic light emitting display panel may further include a plurality of signal pads formed between the first and second power source pads to supply driving signals to the pixel unit. Here, the TCPs may include a first pad unit electrically coupled to at least one of the first and second pads and the signal pads and a second pad unit electrically coupled to the driving boards and the last pads positioned on at least one side of the first pad may be electrically coupled to at least one of the first and second power source pads. The last pads positioned at least one side of each of the first pad unit and the second pad unit may be coupled to each other by the power source lines.

In addition, the first power source pads may be formed at a first edge of the organic light emitting display panel and a second edge that faces the first edge and the second power source pads may be formed in a third edge of the organic light emitting display device and a fourth edge that faces the third edge. Here, the plurality of the first power source pads may be formed at the first and second edges respectively and the plurality of the second power source pads may be formed at the third and fourth edges respectively.

In addition, the first and second power source pads may be formed at different edges of the organic light emitting display panel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a block diagram illustrating an example of an organic light emitting display device constructed as the present invention;

FIG. 2 is a circuit diagram illustrating an example of the pixel of FIG. 1;

FIG. 3 is an exploded perspective view of an organic light emitting display panel and a tape carrier package (TCP) constructed as an embodiment of the present invention;

FIG. 4 is an enlarged plan view of the TCP illustrated in FIG. 3;

FIG. 5 is a coupled perspective view of the organic light emitting display panel and the TCP in FIG. 3; and

FIG. 6 is a coupled perspective view of an organic light emitting display device constructed as an embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

Hereinafter, exemplary embodiments of the present invention will be described in detail with reference to the accompanying drawings.

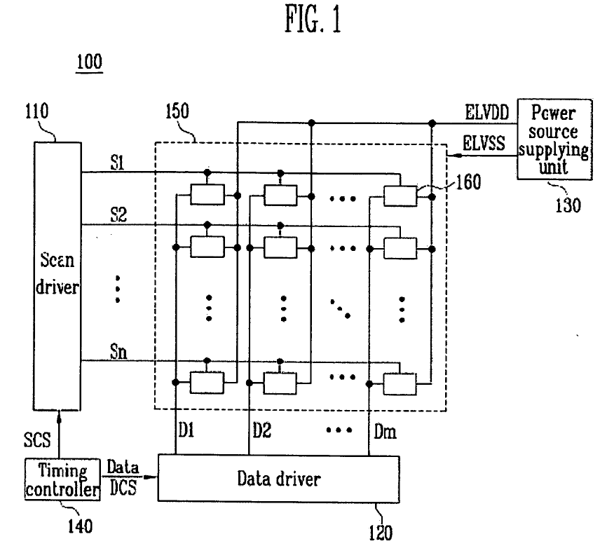

FIG. 1 is a block diagram illustrating an example of an organic light emitting display device constructed as the present invention.

Referring to FIG. 1, an organic light emitting display device 100 includes a scan driver 110, a data driver 120, a timing controller 140, a pixel unit 150, and a power source supplying unit 130.

Scan driver 110 generates scan signals to correspond to scan driving control signals SCS supplied from timing controller 140. The scan signals generated by scan driver 110 are sequentially supplied to scan lines S1 to Sn.

Data driver 120 generates data signals to correspond to data Data and data driving control signals DCS supplied from timing controller 140. The data signals generated by data driver 120 are supplied to data lines D1 to Dm in synchronization with the scan signals.

Timing controller 140 generates the scan driving control signals SCS and the data driving control signals DCS in response to synchronizing signals supplied from the exterior. The scan driving control signals SCS generated by timing controller 140 are supplied to scan driver 110 and the data driving control signals DCS are supplied to data driver 120. In addition, timing controller 140 transmits the data Data supplied from the exterior to data driver 120.

Pixel unit 150 includes a plurality of pixels 160 formed in regions partitioned off by the scan lines S1 to Sn and the data lines D1 to Dm. Pixel unit 150 displays an image to correspond to the scan signals supplied from scan driver 110 and the data signals supplied from data drivel 120.

Power source supplying unit 130 generates first and second pixel power sources ELVDD and ELVSS using an external power source supplied from an external power source supplying apparatus (not shown). Then, power source supplying unit 130 supplies the generated first and second pixel power sources ELVDD and ELVSS to pixel unit 150.

In organic light emitting display device 100, pixel unit 150 is formed in the organic light emitting display panel. Scan driver 110 and/or data driver 120 is mounted on the organic light emitting display panel. Or scan driver 110 and/or data driver 120 is mounted on an additional flexible printed circuit board (FPCB) or tape carrier package (TCP) film in type of an integrated circuit chip, and scan drivel 110 and/or data driver 120 may be electrically coupled to the organic light emitting display panel through a pad unit.

Additionally, power source supplying unit 130 and/or timing controller 140 are mounted on a driving board outside the organic light emitting display panel to be electrically coupled to the organic light emitting display panel and/or the driving FPCBs through the FPCB and/or the TCP.

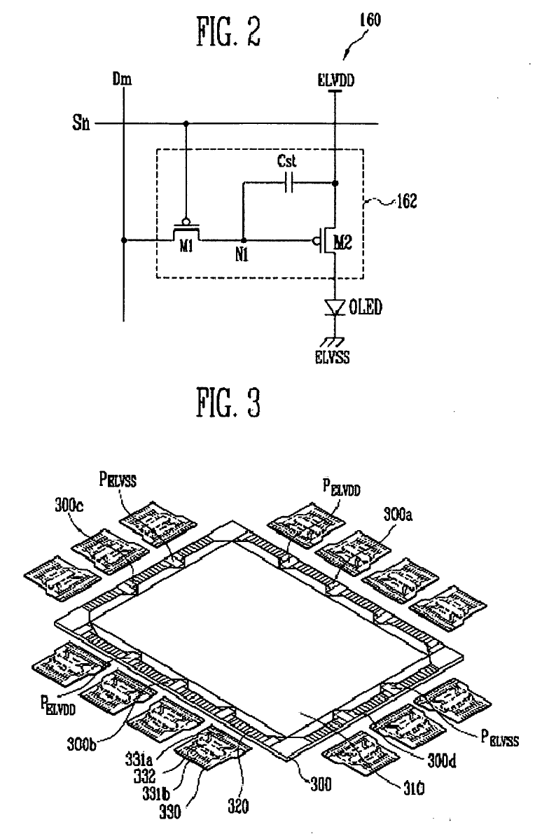

FIG. 2 is a circuit diagram illustrating an example of the pixel of FIG. 1. For convenience, in FIG. 2, a pixel coupled to an nth scan line Sn and an mth data line Dm will be illustrated.

Referring to FIG. 2, a pixel 160 includes an organic light emitting diode OLED, and a pixel circuit 162 electrically coupled to the scan line Sn, the data line Dm, a first pixel power source ELVDD and the OLED.

The anode electrode of the OLED is electrically coupled to pixel circuit 162 and the cathode electrode is electrically coupled to the second pixel power source ELVSS. The OLED emits light with the brightness corresponding to the amount of current supplied from pixel circuit 162.

Pixel circuit 162 includes a first transistor M1, a second transistor M2, and a storage capacitor Cst.

The first electrode of the first transistor M1 is electrically coupled to the data line Dm and the second electrode of the first transistor M1 is electrically coupled to a first node N1. The gate electrode of the first transistor M1 is electrically coupled to the scan line Sn. The first transistor M1 is turned on when a scan signal is supplied to the scan line Sn to transmit a data signal supplied to the data line Dm to the first node N1.

The first electrode of the second transistor M2 is electrically coupled to the first pixel power source ELVDD and the second electrode of the second transistor M2 is electrically coupled to the anode electrode of the OLED. The gate electrode of the second transistor M2 is coupled to the first node N1. The second transistor M2 controls current that flows from the first pixel power source ELVDD to the anode electrode of the OLED to correspond to a voltage supplied to the gate electrode of the second transistor M2.

One terminal of a storage capacitor Cst is electrically coupled to the first node N1 and the other terminal of the storage capacitor Cst is electrically coupled to the first pixel power source ELVDD and the first electrode of the second transistor M2. The storage capacitor Cst stores a voltage corresponding to a data signal supplied to the first node N1 when the scan signal is supplied to the scan line Sn and maintains the stored voltage in one frame.

The operation process of pixel 160 will be described in detail. First, when the scan signal is supplied to the scan line Sn, the first transistor M1 is turned on. When the first transistor M1 is turned on, the data signal supplied to the data line Dm is transmitted to the first node N1 through the first transistor M1. When the data signal is transmitted to the first node N1, a voltage corresponding to a difference between the voltage of the first pixel power source ELVDD and the data signal is charged in the storage capacitor Cst. Then, the second transistor M2 controls current that flows from the first pixel power source ELVDD to the OLED to correspond to a voltage supplied to the gate electrode of the second transistor M2. Therefore, the OLED emits light with brightness corresponding to the amount of current supplied thereto to display an image.

As described above, pixel 160 emits light with brightness corresponding to the amount of current supplied from the second transistor M2. Here, the voltage of the first node N1 to which the gate electrode of the second transistor M2 is electrically coupled is maintained in one frame by the storage capacitor Cst.

The storage capacitor Cst charges a voltage corresponding to a difference between the voltage of the first pixel power source ELVDD and the data signal while the data signal is supplied to maintain the voltage in one frame. Therefore, the emission brightness of pixel 160 varies in accordance with the voltage of the first pixel power source ELVDD and the data signal.

Here, the voltage of the first pixel power source ELVDD supplied to pixels 160 may vary by the voltage drop generated while passing through power source lines. Therefore, pixels 160 that receive the same data signal may emit light with different brightness so that picture quality can deteriorate.

Therefore, a method of minimizing the voltage drop of the first pixel power source ELVDD is to be found. According to the present invention, the method will be provided through the embodiments to be mentioned later.

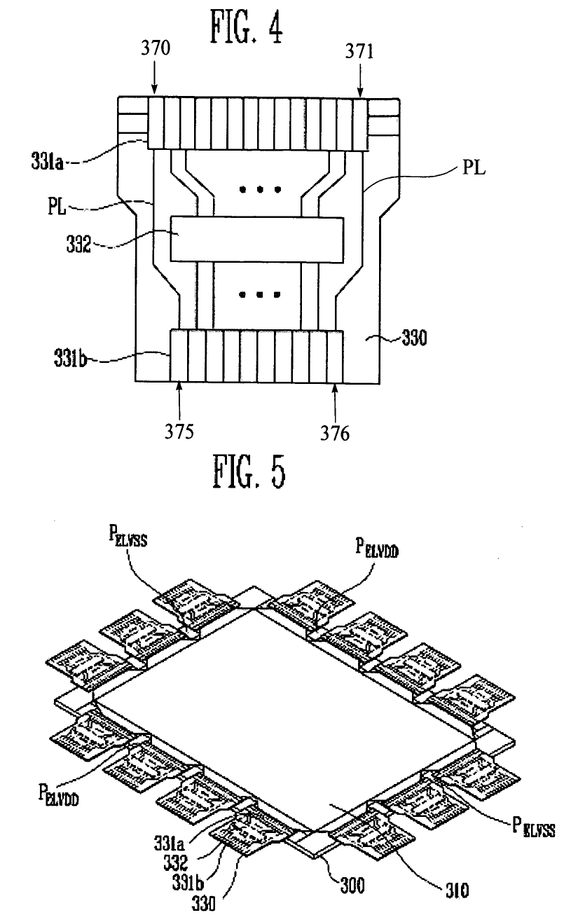

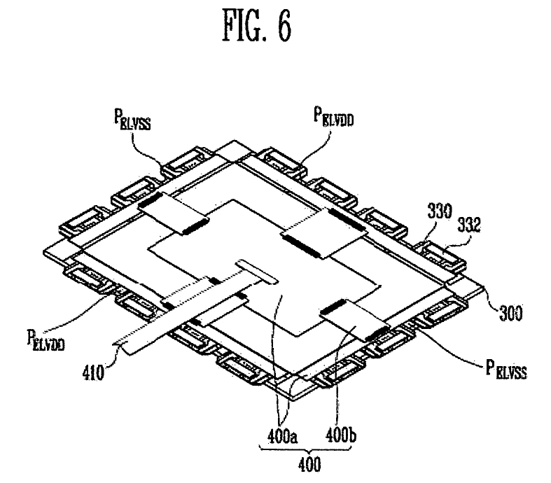

FIG. 3 is all exploded perspective view of an organic light emitting display panel and a tape carrier package (TCP) constructed as an embodiment of the present invention. FIG. 4 is an enlarged plan view of the TCP illustrated in FIG. 3. FIG. 5 is a coupled perspective view of the organic light emitting display panel and the TCP in FIG. 3.

In FIGS. 3 through 5, driving ICs including the scan driver and/or the data driver are not mounted on the organic light emitting display panel but are mounted on an additional tape carrier package (TCP). The present invention, however, is not limited to the above. In addition, in FIG. 4, one side of the TCP on which the driving IC is mounted is illustrated.

Referring to FIGS. 3 through 5, an organic light emitting display panel 300 includes a pixel unit 310 and a plurality of power source pads P_{ELVDD} and P_{ELVSS} and signal pads 320. Here, the plurality of power source pads P_{ELVDD} and P_{ELVSS} and signal pads 320 are positioned at edges 300a, 300b, 300c and 300d outside pixel unit 310 to supply pixel power sources ELVDD and ELVSS and driving signals to pixel unit 310.

Pixel unit 310 includes a plurality of pixels that are not shown. Pixel unit 310 displays an image to correspond to the driving signals supplied from signal pads 320 and the pixel power sources ELVDD and ELVSS supplied from the power source pads P_{ELVDD} and P_{ELVSS}.

The power source pads P_{ELVDD} and P_{ELVSS} are provided at two or more edges of organic light emitting display panel 300.

To be specific, the power source pads P_{ELVDD} and P_{ELVSS} include the first power source pads P_{ELVDD} that receive the first pixel power source ELVDD and the second power source pads P_{ELVSS} that receive the second pixel power source ELVSS.

The first and second power source pads P_{ELVDD} and P_{ELVSS} are dispersed at two or more edges of organic light emitting display panel 300 in order to receive the first and second pixel power sources ELVDD and ELVSS provided from TCPs 330 electrically coupled, in two opposite directions that face each other, to organic light emitting display panel 300.

For example, the plurality of the first power source pads P_{ELVDD} may be formed at the first and second edges 300a and 300b that face each other in organic light emitting display 300 respectively. Therefore, the first power source pads P_{ELVDD} may receive the first pixel power source ELVDD in the both directions and thus transmitting the first pixel power source ELVDD to pixel unit 310.

The plurality of the second power source pads PELVSS may be formed at the third and fourth edges 300c and 300d that face each other in organic light emitting display panel 300 respectively. Therefore, the second power source pads P_{ELVSS} receive the second pixel power source ELVSS in the both directions and thus transmitting the second pixel power source ELVSS to pixel unit 310.

That is, the first power source pads P_{ELVDD} and the second power source pads P_{ELVSS} may be formed at different edges of organic light emitting display panel 300.

The arrangement of the power source pads P_{ELVDD} and P_{ELVSS} according to the present invention is not limited to the above. That is, the first and second power source pads P_{ELVDD} and P_{ELVSS} are provided at three or more edge regions of organic light emitting display panel 300. Therefore, the first and second power source pads P_{ELVDD} and P_{ELVSS} may receive the first and second pixel power sources ELVDD and ELVSS in the at least three different directions. In this case, at least parts of the first and second power source pads P_{ELVDD} and P_{ELVSS} may be formed at the same edge of organic light emitting display panel 300.

Signal pads 320 transmit the driving signals supplied from TCPs 330 to pixel unit 310. The plurality of signal pads 320 may be provided between the first and second power source pads P_{ELVDD} and P_{ELVSS} receptively.

The plurality of TCPs 330 electrically coupled to signal pads 320 may be provided.

Driving ICs 332 for driving organic light emitting display panel 300, in particular, pixel unit 310 is mounted on TCPs 330. Here, scan driving circuits and/or data driving circuits are mounted into driving ICs 332.

Here, TCPs 330 include first and second pad units 331a and 331b. First pad units 331a are electrically coupled to at least one of the first and second power source pads P_{ELVDD} and P_{ELVSS} of organic light emitting display panel 300 and signal pads 320. That is, the first pad units 331a electrically couple organic light emitting display panel 300 and TCPs 330. The second pad units 331b are electrically coupled to driving boards (not shown). That is, the second pad units 331b electrically couple the driving boards and TCPs 330 to each other.

TCPs 330 supply the driving signals such as the scan signals and/or the data signals generated by driving ICs 332 to organic light emitting display 300 to correspond to control signals supplied from the driving boards.

According to the present invention, power source lines PL for transmitting the first and second pixel power sources ELVDD and ELVSS transmitted from the driving boards are provided in the internal lines of TCPs 330. At least one side of each of the first pad units 331a (i.e., at least one of pads 370 and 371), for example, both of pads 370 and 371 disposed at edges of the first pad units 331a are electrically coupled to the first and/or second power source pads P_{ELVDD} and P_{ELVSS} respectively. Here, at least one side of each of the first pad units 331a, for example, both of pads 370 and 371 may be formed to be extended to the first and/or second power source pads P_{ELVDD} and P_{ELVSS}.

Pads 370 and 371 disposed at edge of at least one side of each of the first pad units 331a are respectively electrically coupled to pads 375 and 376 positioned at edge of at least on one side of each of the corresponding second pad units 331b. That is, the power source lines PL respectively electrically couple the pads positioned at edge of at least one side of each of the first pad units 331a and the second pad units 331b to each other. Here, since the plurality of TCPs 330 are provided, the power source lines PL as many as the first and second power source pads P_{ELVDD} and P_{ELVSS} may be formed.

FIG. 6 is a coupled perspective view of an organic light emitting display constructed as an embodiment of the present invention. In the description of FIG. 6, the same parts as the parts of FIGS. 3 through 5 are denoted by the same reference numerals and detailed description thereof will be omitted.

Referring to FIG. 6, the plurality of TCPs 330 electrically coupled to organic light emitting display panel 300 and driving boards 400 electrically coupled to TCPs 330 are provided on one side of organic light emitting display panel 300, for example, on the opposite side that face the side on which an image is displayed.

Here, driving boards 400 include interfaces 410 for transmitting signals and/or power sources supplied from the exterior or boards 400a electrically coupled to TCPs 330 and flexible printed circuit boards (FPCBs) 400b electrically coupled to boards 400a. This structure is merely one embodiment of the present invention and the present invention is not limited to the above.

Timing controllers and/or power source supplying units that are not shown are mounted on driving boards 400 so that driving boards 400 generate control signals for controlling driving ICs 332 and the first and second pixel power sources ELVDD and ELVSS.

Driving boards 400 supply the control signals and the first and second pixel power sources ELVDD and ELVSS to TCPs 330 through the second pad units 331b illustrated in FIGS. 3 to 5.

According to the present invention described above with reference to FIGS. 3 to 6, the power source pads P_{ELVDD} and P_{ELVSS} of organic light emitting display panel 300 are provided at two or more edges. The first and second pixel power sources ELVDD and ELVSS are supplied to organic light emitting display panel 300 in at least two different directions.

Therefore, it is possible to minimize the voltage drop of the first and second pixel power sources ELVDD and ELVSS in organic light emitting display panel 300. Therefore, although the size of organic light emitting display panel 300 increases, it is possible to display an image of uniform picture quality. Therefore, the organic light emitting display may be applied to various displays such as a TV and a sign board.

Additionally, according to the present invention, power source lines PL for coupling the power source pads P_{ELVDD} and P_{ELVSS} provided at the edges of organic light emitting display panel 300 to driving boards 400 on which the power source supplying units are mount are provided in TCPs 330 on which the driving ICs (for example, the scan driver and/or the data driver) are mounted.

Therefore, the pixel power sources ELVDD and ELVSS may be uniformly applied to the inside of organic light emitting display 300 without including additional FPCBs or PCBs. Therefore, it is possible to reduce manufacturing cost and to simplify the structure of a module.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device, comprising:
an organic light emitting display panel comprising a pixel unit on which an image is displayed, and a plurality of first and second power source pads provided at two or more edges surrounding the pixel unit to receive first and second pixel power sources in at least two directions;
a plurality of tape carrier packages (TCP) electrically coupled to the organic light emitting display panel and including driving integrated circuits (ICs) for driving the organic light emitting display panel and power source lines for transmitting the first and second pixel power sources to the first and second power source pads; and
driving boards electrically coupled to the plurality of TCPs to supply control signals for controlling the driving ICs and the first and second pixel power sources to the plurality of TCPs.

2. The organic light emitting display device as claimed in claim 1, with the organic light emitting display panel further comprising a plurality of signal pads formed between the first and second power source pads in order to supply driving signals to the pixel unit.

3. The organic light emitting display device as claimed in claim 2,
with the TCPs further comprising a first pad unit electrically coupled to at least one of the first and second power source pads and the signal pads and a second pad unit electrically coupled to the driving boards, and
with pads positioned at edges of at least one side of the first pad unit being electrically coupled to at least one of the first and second power source pads.

4. The organic light emitting display device as claimed in claim 3, with the pads positioned at the edges of the at least one side of each of the first pad unit and the second pad unit being electrically coupled to each other by the power source lines.

5. The organic light emitting display device as claimed in claim 1,
with the first power source pads being formed at a first edge of the organic light emitting display panel and a second edge that faces the first edge, and
with the second power source pads being formed at a third edge of the organic light emitting display and a fourth edge that faces the third edge.

6. The organic light emitting display device as claimed in claim 5, with the plurality of the first power source pads being formed at the first and second edges respectively.

7. The organic light emitting display device as claimed in claim 5, with the plurality of the second power source pads being formed at the third and fourth edges respectively.

8. The organic light emitting display device as claimed in claim 1, with the first and second power source pads being formed at different edges of the organic light emitting display panel.

9. An organic light emitting display device, comprising:
an organic light emitting display panel comprising a pixel unit on which an image is displayed, and a plurality of first and second power source pads provided on at least two different edges surrounding the pixel unit in order to receive first and second pixel power sources in at least two different directions;
a plurality of tape carrier packages (TCP) being electrically coupled to the organic light emitting display panel, and including driving integrated circuits (ICs) for driving the organic light emitting display panel and power source lines for respectively transmitting the first and second pixel power sources to the first and second power source pads;
driving boards electrically coupled to the plurality of TCPs to supply control signals for controlling the driving ICs and the first and second pixel power sources to the plurality of TCPs; and
the TCPs comprising a pad unit electrically coupled to at least one of the first and second power source pads and the signal pads, and pads positioned at edges of at least one side of the pad unit being electrically coupled to at least one of the first and second power source pads.
